(19) United States
(12) Patent Application Publication
(10) Pub. No.: US 2025/0118859 A1
(43) Pub. Date: Apr. 10, 2025

(54) REDUCING GAS CONTAINER AND METAL-SUPPORTED ELECTROCHEMICAL CELL

(71) Applicant: NGK INSULATORS, LTD., Nagoya-shi (JP)

(72) Inventors: Takashi SHIRATORI, Nagoya-shi (JP); Toshiyuki NAKAMURA, Handa-shi (JP); Genta TERAZAWA, Nagoya-shi (JP); Makoto OHMORI, Nagoya-shi (JP)

(21) Appl. No.: 18/918,471

(22) Filed: Oct. 17, 2024

Related U.S. Application Data
(63) Continuation of application No. PCT/JP2023/036370, filed on Oct. 5, 2023.

(51) Int. Cl. H01M 50/367; H01M 50/26

(52) U.S. Cl. CPC H01M 50/367; H01M 50/26

(57) ABSTRACT

A chromium alloy container has an internal space. The reducing gas container includes a first metal member, a second metal member, and a sealing portion sealing a gap between the first metal member and the second metal member. The sealing portion includes a first bonding portion integrated with the first and second metal members, and a second bonding portion sandwiched between the first and second metal members and disposed on an internal space side of the first bonding portion. The first bonding portion is constituted by a metal material. The second bonding portion is constituted by a crystalline metal oxide.

This is a continuation of PCT/JP2023/036370, filed Oct. 5, 2023, the entire contents of which are hereby incorporated by reference.

### TECHNICAL FIELD

The present invention relates to a reducing gas container and a metal-supported electrochemical cell.

### BACKGROUND ART

JP 2020-181763A discloses a metal-supported fuel cell that includes a reducing gas container and a cell body portion disposed on the reducing gas container.

The reducing gas container is constituted by a porous first metal member that supports the cell body portion, a dense second metal member that, together with the first metal member, forms an internal space through which a reducing gas (e. g., hydrogen) flows, and a sealing portion that seals the gap between the first metal member and the second metal member.

The sealing portion is constituted by a first weld bead, a second weld bead, and a glass paste. The first weld bead is integrated with the first and second metal members and is exposed to the internal space. The second weld bead is integrated with the first and second metal members and is disposed on the side of the first weld bead opposite to the internal space side. The glass paste fills the gap between the first and second weld beads.

### SUMMARY

In the reducing gas container described in JP 2020-181763A, the first weld bead easily deteriorates due to the reducing gas flowing through the internal space, and when the first weld bead deteriorates, the glass paste and second weld bead also successively deteriorate, thus resulting in low mechanical reliability of the sealing portion.

An object of the present invention is to provide a reducing gas container and a metal-supported electrochemical cell that enable improving the mechanical reliability of the sealing portion that seals the gap between the first metal member and the second metal member.

A reducing gas container according to a first aspect of the present invention having an internal space for flow of a reducing gas, the reducing gas container including a first metal member, a second metal member, and a sealing portion sealing a gap between the first metal member and the second metal member. The sealing portion includes a first bonding portion integrated with the first and second metal members, and a second bonding portion sandwiched between the first and second metal members and disposed on an internal space side of the first bonding portion. The first bonding portion is constituted by a metal material. The second bonding portion is constituted by a crystalline metal oxide.

A reducing gas container according to a second aspect of the present invention is the reducing gas container according to the first aspect, wherein the crystalline metal oxide constituting the second bonding portion contains a metal element contained in at least either the first metal member or the second metal member.

A reducing gas container according to a third aspect of the present invention is the reducing gas container according to the second aspect, wherein the second bonding portion is substantially free of boron and silicon.

A reducing gas container according to a fourth aspect of the present invention is the reducing gas container according to the second or third aspect, wherein the crystalline metal oxide constituting the second bonding portion is constituted by at least one of chromium oxide, chromium manganese oxide, and iron oxide.

A reducing gas container according to a fifth aspect of the present invention is the reducing gas container according to any of the first to fourth aspects, wherein a thermal expansion coefficient of the second bonding portion is smaller than thermal expansion coefficients of the first and second metal members.

A reducing gas container according to a sixth aspect of the present invention is the reducing gas container according to any of the first to fifth aspects, wherein the second bonding portion is formed in an annular shape in such a manner as to surround the internal space, and the first bonding portion is formed in an annular shape in such a manner as to surround the second bonding portion.

A reducing gas container according to a seventh aspect of the present invention is the reducing gas container according to the sixth aspect, wherein the first bonding portion includes an intersection portion in a plan view.

A reducing gas container according to an eighth aspect of the present invention is the reducing gas container according to any of the first to seventh aspects, wherein the sealing portion further includes a third bonding portion. The third bonding portion is sandwiched between the first and second metal members and disposed on a side of the first bonding portion opposite to a second bonding portion side. The third bonding portion is constituted by the crystalline metal oxide.

A metal-supported electrochemical cell according to a ninth aspect of the present invention includes the reducing gas container according to any of the first to eighth aspects, and a cell body portion disposed on the reducing gas container. The first metal member has a plurality of communication holes in communication with the internal space. The cell body portion is disposed on the first metal member in such a manner as to cover the plurality of communication holes.

According to the present invention, it is possible to provide a reducing gas container and a metal-supported electrochemical cell that enable improving the mechanical reliability of the sealing portion that seals the gap between the first metal member and the second metal member.

### BRIEF DESCRIPTION OF DRAWINGS

FIG. 1 is a plan view of an electrolysis cell according to an embodiment.

FIG. 2 is a cross-sectional view taken along line A-A in FIG. 1.

FIG. 3 is an enlarged view of a portion of FIG. 2.

FIG. 4 is a plan view of a first sealing portion.

### DESCRIPTION OF EMBODIMENTS

### (Electrolysis Cell 1)

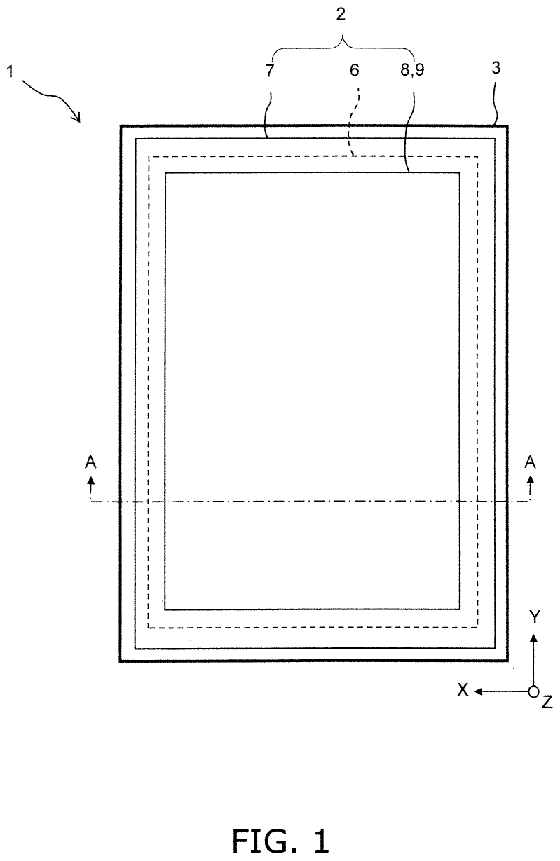

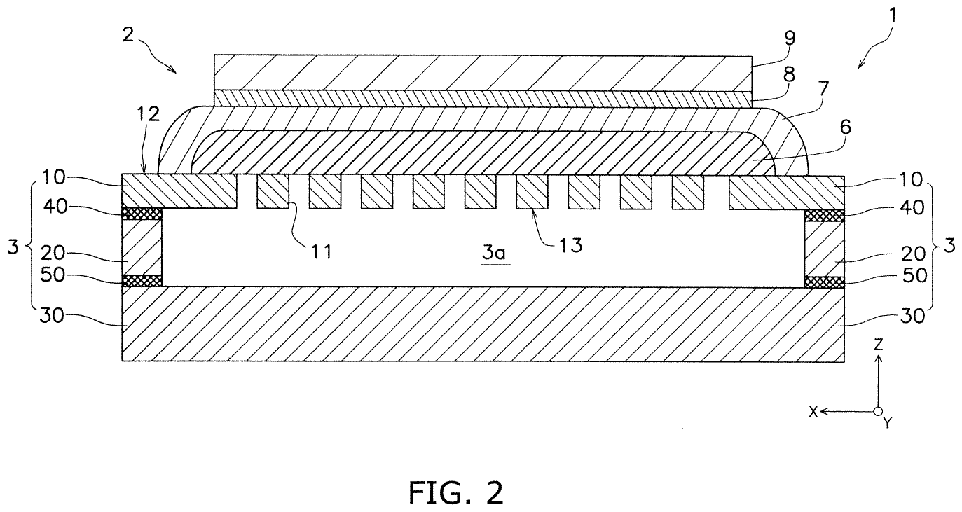

FIG. 1 is a plan view of an electrolysis cell 1 according to an embodiment. FIG. 2 is a cross-sectional view taken along line A-A in FIG. 1.

The electrolysis cell 1 is an example of a “metal-supported electrochemical cell” according to the present invention.

The electrolysis cell 1 is shaped as a plate extending in an X-axis direction and a Y-axis direction. In the present embodiment, the electrolysis cell 1 is shaped as a rectangle extending in the Y-axis direction when viewed in a plan view from a Z-axis direction perpendicular to the X-axis direction and the Y-axis direction. However, the planar shape of the electrolysis cell 1 is not particularly limited, and may be a polygon other than a rectangle, such as an ellipse, a circle, or the like.

As shown in FIGS. 1 and 2, the electrolysis cell 1 includes a cell body portion 2 and a reducing gas container 3.

### (Cell Body Portion 2)

The cell body portion 2 is disposed on the reducing gas container 3. The cell body portion 2 is supported by a later-described metal support 10 of the reducing gas container 3. The cell body portion 2 includes a hydrogen electrode 6 (cathode), an electrolyte 7, a reaction prevention layer 8, and an oxygen electrode 9 (anode).

The hydrogen electrode 6, the electrolyte 7, the reaction prevention layer 8, and the oxygen electrode 9 are stacked in this order from the reducing gas container 3 side in the Z-axis direction. The hydrogen electrode 6, the electrolyte 7, and the oxygen electrode 9 are essential components, whereas the reaction prevention layer 8 is an optional component.

### [Hydrogen Electrode 6]

The hydrogen electrode 6 is disposed on a first main surface 12 of the metal support 10.

A raw material gas is supplied to the hydrogen electrode 6 through supply holes 11 in the metal support 10. The raw material gas contains at least water vapor (H₂O).

When the raw material gas contains only H₂O, the hydrogen electrode 6 produces H₂ from the raw material gas in accordance with water electrolysis, which is the electrochemical reaction shown in the following formula (1).

Hydrogen electrode 6: H₂O+2e⁻→H₂+O²⁻ (1)

When the raw material gas contains CO₂ in addition to H₂O, the hydrogen electrode 6 produces H₂, CO, and O²⁻ from the raw material gas in accordance with co-electrolysis, which are the co-electrochemical reactions shown in the following formulas (2), (3), and (4).

Hydrogen electrode 6: CO₂+H₂O+4e⁻→CO+H₂+2O²⁻ (2)

H₂O electrochemical reaction: H₂O+2e⁻→H₂+O²⁻ (3)

CO₂ electrochemical reaction: CO₂+2e⁻→CO+O²⁻ (4)

H₂ produced in the hydrogen electrode 6 flows out from the supply holes 11 of the metal support 10 into a later-described internal space 3a. In the present embodiment, the H₂ produced in the hydrogen electrode 6 is an example of the “reducing gas” that flows in the internal space 3a.

The hydrogen electrode 6 is a porous body that has electronic conductivity. The hydrogen electrode 6 contains nickel (Ni). In the case of co-electrolysis, Ni functions as an electronic conductor, and also functions as a thermal catalyst that promotes the thermal reaction between the produced H₂ and the CO₂ contained in the raw material gas to maintain an appropriate gas composition for methanation, Fischer-Tropsch (FT) synthesis, and the like. The Ni contained in the hydrogen electrode 6 is essentially present in the form of metal Ni during operation of the electrolysis cell 1, but may also partially be present in the form of nickel oxide (NiO).

The hydrogen electrode 6 may contain an ion conductive material. Examples of the ion conductive material that can be used include yttria-stabilized zirconia (YSZ), calcia-stabilized zirconia (CSZ), scandia-stabilized zirconia (ScSZ), gadolinium-doped ceria (GDC), samarium-doped ceria (SDC), (La, Sr)(Cr, Mn)O₃, (La,Sr)TiO₃, Sr₂(Fe,Mo)₂O₆, (La,Sr)VO₃, (La,Sr)FeO₃, and mixed materials containing two or more of these.

The thickness of the hydrogen electrode 6 is not particularly limited, but can be, for example, 1 μm or more and 100 μm or less. The value of the thermal expansion coefficient of the hydrogen electrode 6 is not particularly limited, but can be, for example, 12×10⁻⁶/° C. or more and 20×10⁻⁶/° C. or less.

The method for forming the hydrogen electrode 6 is not particularly limited, and may be a firing method, a spray coating method (such as a thermal spray method, an aerosol deposition method, an aerosol gas deposition method, a powder jet deposition method, a particle jet deposition method, or a cold spray method), a PVD method (such as a sputtering method or a pulsed laser deposition method), or a CVD method, for example.

### [Electrolyte 7]

The electrolyte 7 is formed on the hydrogen electrode 6. The electrolyte 7 is disposed between the hydrogen electrode 6 and the oxygen electrode 9. In the present embodiment, the electrolyte 7 is sandwiched between the hydrogen electrode 6 and the reaction prevention layer 8 and is connected to both of them.

The electrolyte 7 covers the hydrogen electrode 6 and also covers the region of the first main surface 12 of the metal support 10 that is exposed from the hydrogen electrode 6.

The electrolyte 7 is a dense body that has oxide ion conductivity. The electrolyte 7 transfers O²⁻ produced at the hydrogen electrode 6 toward the oxygen electrode 9. The electrolyte 7 is constituted by an oxide ion conductive material. The electrolyte 7 can be constituted by, for example, YSZ, GDC, ScSZ, SDC, LSGM (lanthanum gallate), or the like, with YSZ being particularly preferable.

The thickness of the electrolyte 7 is not particularly limited, but can be, for example, 1 μm or more and 100 μm or less. The value of the thermal expansion coefficient of the electrolyte 7 is not particularly limited, but can be, for example, 10×10⁻⁶/° C. or more and 12×10⁻⁶/° C. or less.

The method for forming the electrolyte 7 is not particularly limited, and a firing method, a spray coating method, a PVD method, a CVD method, or the like can be used.

### [Reaction Prevention Layer 8]

The reaction prevention layer 8 is disposed between the electrolyte 7 and the oxygen electrode 9. The reaction prevention layer 8 is disposed on the side of the electrolyte 7 opposite to the hydrogen electrode 6 side. The reaction prevention layer 8 suppresses the formation of a layer with high electrical resistance caused by constituent elements of the electrolyte 7 reacting with constituent elements of the oxygen electrode 9.

The reaction prevention layer 8 is constituted by an oxide ion conductive material. The reaction prevention layer 8 can be constituted by GDC, SDC, or the like.

The porosity of the reaction prevention layer 8 is not particularly limited, but can be, for example, 0.1% or more and 50% or less. The thickness of the reaction prevention layer 8 is not particularly limited, but may be, for example, 1 μm or more and 50 μm or less.

The method for forming the reaction prevention layer 8 is not particularly limited, and a firing method, a spray coating method, a PVD method, a CVD method, or the like can be used.

### [Oxygen Electrode 9]

The oxygen electrode 9 is disposed on the side of the electrolyte 7 opposite to the hydrogen electrode 6 side. In the present embodiment, the reaction prevention layer 8 is disposed between the electrolyte 7 and the oxygen electrode 9, and therefore the oxygen electrode 9 is connected to the reaction prevention layer 8. When the reaction prevention layer 8 is not disposed between the electrolyte 7 and the oxygen electrode 9, the oxygen electrode 9 is connected to the electrolyte 7.

The oxygen electrode 9 produces O₂ from O²⁻ transferred from the hydrogen electrode 6 via the electrolyte 7 in accordance with the chemical reaction of the following formula (5).

Oxygen electrode 9: 2O²⁻→O₂+4e⁻ (5)

The oxygen electrode 9 is a porous body that has oxide ion conductivity and electronic conductivity. The oxygen electrode 9 can be formed of a composite material containing an oxide ion conductive material (such as GDC) and one or more of (La,Sr)(Co, Fe)O₃, (La, Sr)FeO₃, La(Ni,Fe)O₃, (La,Sr)CoO₃, and (Sm,Sr)CoO₃.

The porosity of the oxygen electrode 9 is not particularly limited, but can be, for example, 20% or more and 60% or less. The thickness of the oxygen electrode 9 is not particularly limited, but can be, for example, 1 μm or more and 100 μm or less.

The method for forming the oxygen electrode 9 is not particularly limited, and a firing method, a spray coating method, a PVD method, a CVD method, or the like can be used.

### (Reducing Gas Container 3)

The reducing gas container 3 includes the internal space 3athrough which the raw material gas supplied to the hydrogen electrode 6 and the reducing gas (H₂ in the present embodiment) produced in the hydrogen electrode 6 flow.

In the present embodiment, the reducing gas container

3 includes the metal support 10, a frame 20, an interconnector 30, a first sealing portion 40, and a second sealing portion 50. The internal space 3a is a space surrounded by the metal support 10, the frame 20, the interconnector 30, the first sealing portion 40, and the second sealing portion 50. The first sealing portion 40 and the second sealing portion 50 are each an example of the “sealing portion” according to the present invention.

In the present embodiment, either the metal support 10 or the frame 20 is an example of the “first metal member” according to the present invention, and the other one is an example of the “second metal member” according to the present invention. Also, in the present embodiment, either the frame 20 or the interconnector 30 is an example of the “first metal member” according to the present invention, and the other one is an example of the “second metal member” according to the present invention.

### [Metal Support 10]

The metal support 10 supports the cell body portion 2. In the present embodiment, the metal support 10 is formed in a plate shape. The metal support 10 may be shaped as a flat plate or a curved plate.

The metal support 10 is only required to be able to support the cell body portion 2, and the thickness is not particularly limited, but can be, for example, 0.1 mm or more and 2.0 mm or less.

As shown in FIG. 2, the metal support 10 includes the supply holes 11, the first main surface 12, and the second main surface 13.

The supply holes 11 pass through the metal support 10 from the first main surface 12 to the second main surface 13. The supply holes 11 are open at both the first main surface 12 and the second main surface 13. The supply holes 11 are covered by the cell body portion 2. Specifically, the openings of the supply holes 11 on the first main surface 12 side are covered by the hydrogen electrode 6. The openings of the supply holes 11 on the second main surface 13 side are in communication with the internal space 3a.

The supply holes 11 can be formed by mechanical processing (e.g., punching), laser processing, chemical processing (e.g., etching), or the like.

In the present embodiment, the supply holes 11 extend straight along the Z-axis direction. However, the supply holes 11 may be inclined with respect to the Z-axis direction, and do not need to be linear. Moreover, the supply holes 11 may be connected to each other.

The first main surface 12 is provided on the side opposite to the second main surface 13. The cell body portion 2 is disposed on the first main surface 12. The frame 20 is joined to the second main surface 13 via the first sealing portion 40.

The metal support 10 is constituted by a metal material. For example, the metal support 10 can be constituted by an alloy material containing Cr (chromium). Examples of such metal materials include Fe—Cr alloy steel (such as stainless steel) and Ni—Cr alloy steel. The Cr content in the metal support 10 is not particularly limited, but can be set to 4 mass % or more and 30 mass % or less.

The metal support 10 may contain Ti (titanium) and/or Zr (zirconium). The Ti content in the metal support 10 is not particularly limited, but can be set to 0.01 mol % or more and 1.0 mol % or less. The Al content in the metal support 10 is not particularly limited, but can be set to 0.01 mol % or more and 0.4 mol % or less. The metal support 10 may contain Ti as TiO₂ (titania) and Zr as ZrO₂ (zirconia).

### [Frame 20]

The frame 20 is a spacer for forming the internal space 3a. In the present embodiment, the frame 20 is formed in an annular shape.

The frame 20 is joined to the metal support 10 via the first sealing portion 40, and is joined to the interconnector 30 via the second sealing portion 50.

The thickness of the frame 20 is not particularly limited, but may be, for example, 0.1 mm or more and 2.0 mm or less.

The frame 20 is constituted by a metal material. For example, the frame 20 can be constituted by the above-described alloy materials. The composition of the frame 20 may be the same as or different from that of the metal support 10.

### [Interconnector 30]

The interconnector 30 is disposed on the side of the frame 20 opposite to the metal support 10 side. The interconnector 30 is a member for electrically connecting the electrolysis cell 1 to an external power source or another electrolysis cell.

In the present embodiment, the interconnector 30 is formed in a plate shape. The interconnector 30 may be shaped as a flat plate or a curved plate.

The interconnector 30 is joined to the frame 20 via the second sealing portion 50.

The thickness of the interconnector 30 is not particularly limited, but can be, for example, 0.1 mm or more and 2.0 mm or less.

The interconnector 30 is constituted by a metal

material. For example, the interconnector 30 can be constituted by the above-described alloy materials. The composition of the interconnector 30 may be the same as or different from that of the metal support 10. The composition of the interconnector 30 may be the same as or different from that of the frame 20.

### [First Sealing Portion 40]

The first sealing portion 40 is disposed between the metal support 10 and the frame 20. The first sealing portion 40 is joined to both the metal support 10 and the frame 20.

The first sealing portion 40 seals the gap between the metal support 10 and the frame 20. This prevents the raw material gas supplied to the hydrogen electrode 6 and the reducing gas produced in the hydrogen electrode 6 from leaking to the outside through the gap between the metal support 10 and the frame 20. The detailed configuration of the first sealing portion 40 will be described later.

### [Second Sealing Portion 50]

The second sealing portion 50 is disposed between the frame 20 and the interconnector 30. The second sealing portion 50 is joined to both the frame 20 and the interconnector 30.

The second sealing portion 50 seals the gap between the frame 20 and the interconnector 30. This prevents the raw material gas supplied to the hydrogen electrode 6 and the reducing gas produced in the hydrogen electrode 6 from leaking to the outside through the gap between the frame 20 and the interconnector 30.

The configuration of the second sealing portion 50 is the same as the configuration of the first sealing portion 40, which will be described next, and therefore, in the present embodiment, a description will not be given for the configuration of the second sealing portion 50.

### (Detailed Configuration of First Sealing Portion 40)

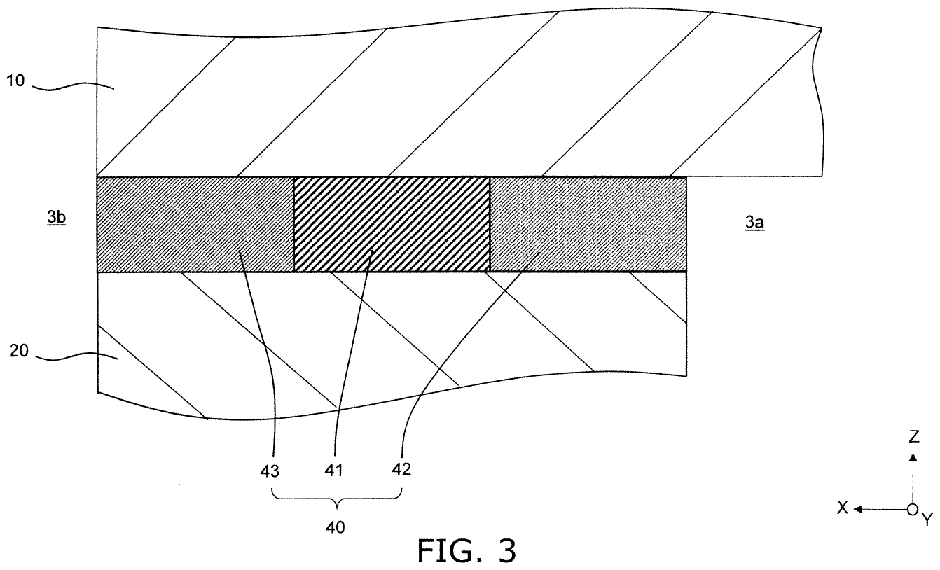

FIG. 3 is an enlarged view of a portion of FIG. 2. A cross section of the first sealing portion 40 is shown in FIG. 3.

The first sealing portion 40 includes a first bonding portion 41, a second bonding portion 42, and a third bonding portion 43.

### [First Bonding Portion 41]

The first bonding portion 41 is disposed between the metal support 10 and the frame 20. The first bonding portion 41 is bonded to both the metal support 10 and the frame 20. The first bonding portion 41 is integrated with the metal support 10 and the frame 20.

The first bonding portion 41 is constituted by a metal material. The composition of the first bonding portion 41 may be the same as the composition of the metal support 10, may be the same as the composition of the frame 20, or may be a mixture of the composition of the metal support 10 and the composition of the frame 20. Furthermore, the composition of the first bonding portion 41 may be different from the compositions of the metal support 10 and the frame 20.

The first bonding portion 41 can be formed, for example, by welding the metal support 10 and the frame 20 together, or by brazing the metal support 10 and the frame 20 together. The first bonding portion 41 according to the present embodiment is formed by lap-welding the metal support 10 and the frame 20.

In the present embodiment, the first bonding portion 41 is disposed on the side of the second bonding portion 42 opposite to the internal space 3a side. In other words, the first bonding portion 41 is isolated from the internal space 3a by the second bonding portion 42. Therefore, the first bonding portion 41 is not exposed to the internal space 3a.

This makes it possible to suppress the case where the reducing gas (H₂ in the present embodiment) flowing through the internal space 3a comes into contact with the first bonding portion 41, thereby making it possible to suppress deterioration (e.g., embrittlement) of the first bonding portion 41 caused by the reducing gas. Moreover, in the present embodiment, it is possible to suppress the case where water vapor flowing through the internal space 3a comes into contact with the first bonding portion 41, thereby making it possible to suppress corrosion of the first bonding portion 41 caused by water vapor.

In the present embodiment, the first bonding portion 41 is disposed on the side of the third bonding portion 43 opposite to the external space 3b side. In other words, the first bonding portion 41 is isolated from the external space 3b by the third bonding portion 43. Therefore, the first bonding portion 41 is not exposed to the external space 3b.

This makes it possible to suppress the case where water vapor contained in the air in the external space 3b comes into contact with the first bonding portion 41, thereby further suppressing corrosion of the first bonding portion 41 caused by water vapor.

### [Second Bonding Portion 42]

The second bonding portion 42 is disposed between the metal support 10 and the frame 20. The second bonding portion 42 is sandwiched between the metal support 10 and the frame 20. The second bonding portion 42 is disposed on the internal space 3a side of the first bonding portion 41. The inner peripheral surface of the second bonding portion 42 is exposed to the internal space 3a.

The second bonding portion 42 is constituted by a crystalline metal oxide. Crystalline metal oxides have higher chemical stability against reducing gases and water vapor than metal materials. Therefore, due to the second bonding portion 42, which comes into contact with the reducing gas and water vapor flowing through the internal space 3a, being constituted by a crystalline metal oxide, deterioration of the second bonding portion 42 can be suppressed. Therefore, in addition to being able to suppress deterioration of the first bonding portion 41 as described above, the mechanical reliability of the first sealing portion 40 can be improved.

It is preferable that the crystalline metal oxide that constitutes the second bonding portion 42 contains a metal element contained in at least either the metal support 10 or the frame 20. This makes it possible to improve the close adhesion between the second bonding portion 42 and at least either the metal support 10 or the frame 20. As a result, the sealing of the gap between the metal support 10 and the frame 20 can be improved, thereby making it possible to further suppress contact between the first bonding portion 41 and the reducing gas or water vapor.

It is preferable that the second bonding portion 42 is substantially free of boron (element B) and silicon (element Si). Due to the second bonding portion 42 not containing vitreous matter, the chemical stability of the second bonding portion 42 against reducing gas and water vapor can be further improved. Also, being substantially free of boron and silicon means that when the contents of boron and silicon are measured using an energy dispersive spectroscopy (EDS) device, the respective contents of boron and silicon are below the detection limit, or are 1 mol % or less.

It is preferable that the crystalline metal oxide that constitutes the second bonding portion 42 is constituted by at least one of chromium oxide, chromium manganese oxide, and iron oxide. These oxides have high chemical stability against the reducing gas and water vapor, thereby making it possible to further suppress deterioration of the second bonding portion 42.

One example of chromium oxides is Cr₂O₃. Examples of chromium manganese oxides include MnCr₂O₄ (spinel) and Mn_{1,5}Cr_{1,5}O₄ (spinel). Examples of iron oxides include FeO, Fe₂O₃, and Fe₃O₄.

It is preferable that the thermal expansion coefficient of the second bonding portion 42 is smaller than the thermal expansion coefficient of the metal support 10 and smaller than the thermal expansion coefficient of the frame 20. As a result, when the temperature of the reducing gas container 3 decreases, compressive force can be applied to the second bonding portion 42 by the metal support 10 and the frame 20, thereby making it possible to improve the strength of the second bonding portion 42.

The second bonding portion 42 can be formed as follows. First, a paste containing a crystalline metal oxide is applied to the surface of at least either the metal support 10 or the frame 20. Next, the metal support 10 and the frame 20 are welded together to form the first bonding portion 41. Next, the paste is fired to form the second bonding portion 42. The firing conditions can be appropriately set, for example, at 600° C. or higher and 1100° C. or lower, and for 0.5 hours or more and 24 hours or less.

### [Third Bonding Portion 43]

The third bonding portion 43 is disposed between the metal support 10 and the frame 20. The third bonding portion 43 is sandwiched between the metal support 10 and the frame 20. The third bonding portion 43 is disposed on the side of the first bonding portion 41 opposite to the second bonding portion 42 side. The outer peripheral surface of the third bonding portion 43 is exposed to the external space 3b.

The third bonding portion 43 is constituted by a crystalline metal oxide. Therefore, it is possible to suppress chemical deterioration of the third bonding portion 43 caused by water vapor contained in the air in the external space 3b. Therefore, in addition to being able to suppress deterioration of the first bonding portion 41 and the second bonding portion 42 as described above, the mechanical reliability of the first sealing portion 40 can be further improved.

The crystalline metal oxide that constitutes the third bonding portion 43 may be the same as the crystalline metal oxide that constitutes the second bonding portion 42, or may be different.

It is preferable that the crystalline metal oxide that constitutes the third bonding portion 43 contains a metal element contained in at least either the metal support 10 or the frame 20. This makes it possible to improve the adhesion between the third bonding portion 43 and at least either the metal support 10 or the frame 20. As a result, the sealing of the gap between the metal support 10 and the frame 20 can be improved, thereby making it possible to further suppress contact between the first bonding portion 41 and water vapor contained in air in the external space 3b.

It is preferable that the third bonding portion 43 is substantially free of boron and silicon. Due to the third bonding portion 43 not containing vitreous matter, it is possible to further suppress chemical deterioration of the third bonding portion 43 caused by water vapor.

It is preferable that the crystalline metal oxide that constitutes the third bonding portion 43 is constituted by at least one of chromium oxide, chromium manganese oxide, and iron oxide. This makes it possible to further suppress deterioration of the third bonding portion 43.

It is preferable that the thermal expansion coefficient of the third bonding portion 43 is smaller than the thermal expansion coefficient of the metal support 10 and smaller than the thermal expansion coefficient of the frame 20. As a result, when the temperature of the reducing gas container 3 decreases, compressive force can be applied to the third bonding portion 43 by the metal support 10 and the frame 20, thereby making it possible to improve the strength of the third bonding portion 43.

The third bonding portion 43 can be formed as follows. First, a paste containing a crystalline metal oxide is applied to the surface of at least either the metal support 10 or the frame 20. Next, the metal support 10 and the frame 20 are welded together to form the first bonding portion 41. Next, the paste is fired to form the second bonding portion 42. The firing conditions can be appropriately set, for example, at 600° C. or higher and 1100° C. or lower, and for 0.5 hours or more and 24 hours or less. The third bonding portion 43 can be formed at the same time as the second bonding portion 42.

### (Planar Shape of First Sealing Portion 40)

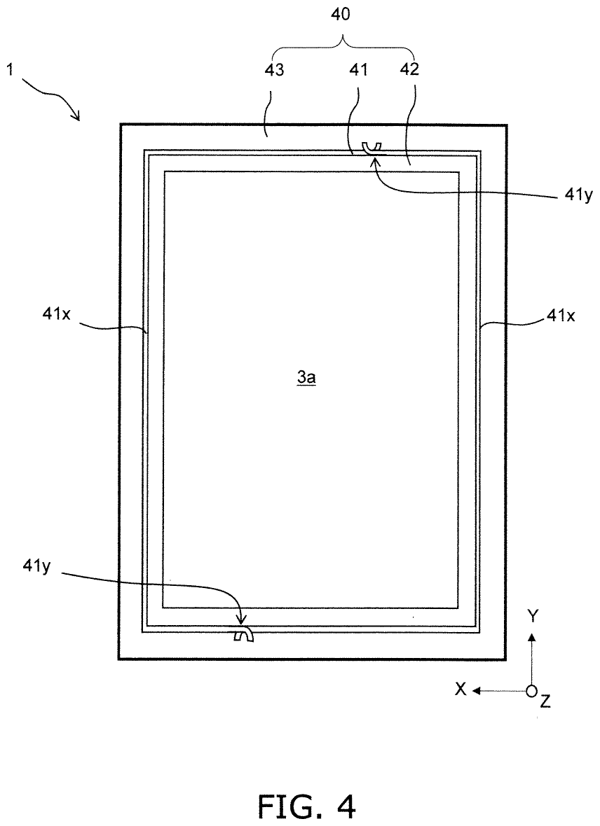

FIG. 4 is a plan view of the first sealing portion 40 as viewed from the metal support 10 side.

In the present embodiment, the first sealing portion 40 is formed in an annular shape so as to surround the internal space 3a. Specifically, the second bonding portion 42 is formed in an annular shape so as to surround the internal space 3a, the first bonding portion 41 is formed in an annular shape so as to surround the second bonding portion 42, and the third bonding portion 43 is formed in an annular shape so as to surround the first bonding portion 41. This makes it possible to ensure that the internal space 3a is sealed reliably.

As shown in FIG. 4, the first bonding portion 41 has a plurality of short bonding portions 41x and a plurality of intersection portions 41y. The first bonding portion 41 has a configuration in which the short bonding portions 41x are connected to each other in the intersection portions 41y.

By cross-connecting the short bonding portions 41x in this manner, the formation of gaps between the short bonding portions 41x can be suppressed compared to the case of butt-jointing. Therefore, the sealing performance of the first sealing portion 40 can be further improved.

However, the first bonding portion 41 does not need to include a plurality of short bonding portions 41x. Even in this case, it is preferable that the two ends of the first bonding portion 41 are connected in an intersection portion 41y.

### (Variations)

Although embodiments of the present invention have been described above, the present invention is not limited to these embodiments, and various modifications can be made without departing from the spirit of the present invention.

### [Variation 1]

In the above embodiments, the frame 20 and the interconnector 30 are separate members, but the frame 20 and the interconnector 30 may be an integrated member. In this case, the reducing gas container 3 does not include the second sealing portion 50.

### [Variation 2]

In the above embodiments, the metal support 10 and the frame 20 are separate members, but the metal support 10 and the frame 20 may be an integrated member. In this case, the reducing gas container 3 does not include the first sealing portion 40.

### [Variation 3]

In the above embodiments, the first bonding portion 41 is formed by lap welding the metal support 10 and the frame 20, but the first bonding portion 41 may also be formed by edge welding the outer edges of the metal support 10 and the frame 20 together. In this case, the first sealing portion 40 does not need to have the third bonding portion 43.

### [Variation 4]

In the above embodiments, an electrolysis cell has been described as an example of an electrochemical cell, but the electrochemical cell is not limited to an electrolysis cell. An electrochemical cell is a general term for an element in which a pair of electrodes are arranged so that electromotive force is produced from an overall oxidation-reduction reaction in order to convert electrical energy into chemical energy, and for an element for converting chemical energy into electrical energy. Thus, electrochemical cells include, for example, fuel cells that use oxide ions or protons as carriers.

### [Variation 5]

In the above embodiments, the reducing gas container according to the present invention is applied to an electrochemical cell, but the reducing gas container can be used for various purposes that use a reducing gas. The reducing gas container can be applied to, for example, a methanation reactor for synthesizing methane from hydrogen and carbon dioxide.

### REFERENCE SIGNS LIST

1 Electrolysis cell

2 Cell body portion

3 Reducing gas container

3a Internal space

6 Hydrogen electrode

7 Electrolyte

8 Reaction prevention layer

9 Oxygen electrode

10 Metal support

11 Supply hole

12 First main surface

13 Second main surface

20 Frame

30 Interconnector

40 First sealing portion

50 Second sealing portion

1. A reducing gas container having an internal space for flow of a reducing gas, the reducing gas container comprising:
a first metal member;
a second metal member; and
a sealing portion sealing a gap between the first metal member and the second metal member, wherein
the sealing portion includes
a first bonding portion integrated with the first and second metal members, and
a second bonding portion sandwiched between the first and second metal members and disposed on an internal space side of the first bonding portion,
the first bonding portion is constituted by a metal material, and
the second bonding portion is constituted by a crystalline metal oxide.

2. The reducing gas container according to claim 1, wherein
the crystalline metal oxide constituting the second bonding portion contains a metal element contained in at least either the first metal member or the second metal member.

3. The reducing gas container according to claim 2, wherein
the second bonding portion is substantially free of boron and silicon.

4. The reducing gas container according to claim 2, wherein
the crystalline metal oxide constituting the second bonding portion is constituted by at least one of chromium oxide, chromium manganese oxide, and iron oxide.

5. The reducing gas container according to claim 1, wherein
a thermal expansion coefficient of the second bonding portion is smaller than thermal expansion coefficients of the first and second metal members.

6. The reducing gas container according to claim 1, wherein
the second bonding portion is formed in an annular shape in such a manner as to surround the internal space, and
the first bonding portion is formed in an annular shape in such a manner as to surround the second bonding portion.

7. The reducing gas container according to claim 6, wherein
the first bonding portion includes an intersection portion in a plan view.

8. The reducing gas container according to claim 1, wherein
the sealing portion further includes a third bonding portion,
the third bonding portion is sandwiched between the first and second metal members and disposed on a side of the first bonding portion opposite to a second bonding portion side, and
the third bonding portion is constituted by the crystalline metal oxide.

9. A metal-supported electrochemical cell comprising:
the reducing gas container according to claim 1; and
a cell body portion disposed on the reducing gas container, wherein
the first metal member has a plurality of communication holes in communication with the internal space, and
the cell body portion is disposed on the first metal member in such a manner as to cover the plurality of communication holes.
